(19) United States
(12) Patent Application Publication
(10) Pub. No.: US 2025/0186926 A1
(43) Pub. Date: Jun. 12, 2025

(54) AIR FILTER SYSTEM FOR DETECTING A TEMPERATURE DIFFERENTIAL TO INDICATE A NEED FOR SERVICING

(71) Applicant: K&N Engineering, Inc., Riverside, CA (US)

(72) Inventors: Steve Williams, Cherry Valley, CA (US); Joost Adriaans, Riverside, CA (US)

(73) Assignee: K&N Engineering, Inc., Riverside, CA (US)

(21) Appl. No.: 18/979,435

(22) Filed: Dec. 12, 2024

Related U.S. Application Data
(60) Provisional application No. 63/609,285, filed on Dec. 12, 2023.

(51) Int. Cl. B01D 46/00; F24F 8/108

(52) U.S. Cl. CPC B01D 46/0086; B01D 46/0005; F24F 8/108; B01D 2279/50

(57) ABSTRACT

A system and methods are provided for an air filter that detects a temperature differential across the filter, due to contaminant buildup, and indicates when the filter needs to be serviced. The air filter comprises a filter medium supported within a frame and a differential temperature sensor incorporated into the frame. The frame supports the filter medium within a HVAC system, and the filter medium removes contaminants from an airstream flowing through the HVAC system. The differential temperature sensor signals when air pressure across the air filter reaches a threshold value due to contaminant buildup within the filter medium. The differential temperature sensor includes circuitry that wirelessly signals an application stored on a user's mobile device to display a notification to the user when the air filter needs to be cleaned or replaced to minimize energy consumption by the HVAC system.

### PRIORITY

This application claims the benefit of and priority to U.S. Provisional Application, entitled “Air Filter System For Detecting A Temperature Differential To Indicate A Need For Servicing,” filed on Dec. 12, 2023, and having application Ser. No. 63/609,285, the entirety of said application being incorporated herein by reference.

### FIELD

Embodiments of the present disclosure generally relates to filter devices. More specifically, embodiments of the disclosure relate to a system and methods for an air filter that can detect a temperature differential across the filter, due to contaminant buildup, and thus provide insight as to when to periodically service the filter.

### BACKGROUND

An air filter designed to remove particulate matter from an airstream generally is a device comprising fibrous materials. These fibrous materials can remove solid particulates such as dust, pollen, mold, and bacteria from an airstream. Air filters are used in applications where air quality is important, notably in heating, ventilation, and air conditioning (HVAC) systems of buildings. HVAC systems generally operate to provide optimal interior air quality to occupants within interior spaces of buildings. HVAC systems achieve optimal interior air quality by conditioning air, removing particle contaminants by way of ventilation and filtration of air, and providing a proper interior pressurization.

While there are many different HVAC system designs and operational approaches, and each building design is unique, HVAC systems generally share a few basic design elements. For example, outside air (“supply air”) generally is drawn into a HVAC system through an air intake. Once in the HVAC system, the supply air is filtered to remove particle contaminants, then heated or cooled, and then circulated throughout the interior space of the building by way of an air distribution system. Many air distribution systems comprise a return air system configured to draw air from the interior building space and return the air (“return air”) to the HVAC system. The return air may then be mixed with supply air and then filtered, conditioned, and circulated throughout the interior space of the building. In some instances, a portion of the air circulating within the building may be exhausted to the exterior so as to maintain a desired barometric pressure within the building.

As will be appreciated, the effectiveness of the HVAC system to provide an optimal interior air quality depends largely on an ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. Filters may be made from paper, foam, cotton, spun fiberglass, or other known filter materials. The filter material may also be pleated so as to increase the surface area and, accordingly, increase the efficiency of the filter. As will be appreciated, an increase in the number of pleats for a given area will proportionally increase the surface area and therefore the efficiency of the filter.

A drawback to conventional HVAC system air filters is that highly effective air filters capable of removing very small contaminants, such as airborne molecular contaminants and volatile organic compounds (VOCs), tend to restrict airflow through the air filter, thereby making the HVAC system work harder and consume more energy. As such an air filter becomes increasingly clogged with contaminants, the pressure downstream of the filter drops while the atmospheric air pressure upstream of the filter remains the same. When the pressure differential becomes too great, due to clogging, the filter may tear or burst, allowing contaminants to be pulled beyond the air filter. Thus, the performance of a conventional HVAC system air filter (i.e., air flow through the filter and its ability to remove contaminants from the airstream) decreases over the course of the filter's service life.

Another drawback to conventional HVAC system air filters is that dirty or clogged air filters typically must be removed from the HVAC system and discarded, and a new HVAC system air filter must be installed. As such, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is a staggering number.

What is needed, therefore, is a HVAC system air filter that can detect a pressure differential across the filter, due to contaminant buildup, and thus provide insight as to when to periodically clean and reuse the filter so as to minimize obstructing air flow through the HVAC system.

### SUMMARY

A system and methods are provided for an air filter that detects a temperature differential across the filter, due to contaminant buildup, and indicates when the filter needs to be serviced. The air filter comprises a filter medium supported within a frame and a differential temperature sensor incorporated into the frame. The frame supports the filter medium within a HVAC system, and the filter medium removes contaminants from an airstream flowing through the HVAC system. The differential temperature sensor signals when air pressure across the air filter reaches a threshold value due to contaminant buildup within the filter medium. The differential temperature sensor includes circuitry that wirelessly signals an application stored on a user's mobile device to display a notification to the user when the air filter needs to be cleaned or replaced to minimize energy consumption by the HVAC system.

In an exemplary embodiment, an air filter for a HVAC system, comprising: a filter medium comprising one or more media layers for removing contaminants from an airstream; a frame for supporting the filter medium within the HVAC system; and a differential temperature sensor for determining a pressure difference across the filter medium.

In another exemplary embodiment, the differential temperature sensor is incorporated into the frame. In another exemplary embodiment, the differential temperature sensor comprises: an upstream temperature sensor; a downstream temperature sensor; and circuitry configured to receive signals from the upstream temperature sensor and the downstream temperature sensor. In another exemplary embodiment, one or both of the upstream temperature sensor and the downstream temperature sensor comprise probe thermistors configured to be disposed in the airstream. In another exemplary embodiment, the circuitry is disposed in a remote location of the HVAC system and is electrically coupled with the differential temperature sensor.

In another exemplary embodiment, the upstream temperature sensor and the downstream temperature sensor are positioned within the airstream respectively upstream and downstream of the filter medium. In another exemplary embodiment, the upstream temperature sensor is configured to measure a first temperature of the airstream upstream of the filter medium while the downstream temperature sensor is configured to measure a second temperature of the airstream downstream of the filter medium. In another exemplary embodiment, the circuitry is configured to determine a temperature difference between the first temperature and the second temperature.

In another exemplary embodiment, the circuitry is configured to use the temperature difference to determine a pressure difference between a low-pressure side of the filter medium and an atmospheric-pressure side of the filter medium. In another exemplary embodiment, the circuitry is configured to provide a signal to a practitioner that the air filter requires cleaning or replacement when the pressure difference reaches a predetermined threshold value. In another exemplary embodiment, the circuitry is configured to wirelessly communicate the with any one or more of a desktop, a tablet, a server, a mobile phone, a personal digital assistant, a personal communicator, a network router or hub, a wireless access point or repeater, a set-top box, or any combination thereof.

In another exemplary embodiment, the differential temperature sensor comprises: at least one temperature sensor coupled with the filter medium; and circuitry configured to receive signals from the at least one at least one temperature sensor.

In another exemplary embodiment, the at least one temperature sensor comprises an upstream temperature sensor and a downstream temperature sensor. In another exemplary embodiment, the at least one temperature sensor is attached to the filter medium on either an atmospheric-pressure side or a low-pressure side of the air filter. In another exemplary embodiment, the at least one temperature sensor comprises an ultrathin thermistor having a thermally sensitive resistor and corresponding electrical connections that are housed within an epoxy-coated portion.

In another exemplary embodiment, the at least one temperature sensor is configured to measure a filter temperature of the filter medium. In another exemplary embodiment, the circuitry is configured to determine a temperature difference between the filter temperature and a temperature of the airstream upstream of the filter medium. In another exemplary embodiment, the circuitry is configured to use the temperature difference to determine a pressure difference between a low-pressure side of the filter medium and an atmospheric-pressure side of the filter medium. In another exemplary embodiment, the circuitry is configured to provide a signal to a practitioner that the air filter requires cleaning or replacement when the pressure difference reaches a predetermined threshold value. In another exemplary embodiment, the circuitry is configured to wirelessly communicate the with any one or more of a desktop, a tablet, a server, a mobile phone, a personal digital assistant, a personal communicator, a network router or hub, a wireless access point or repeater, a set-top box, or any combination thereof.

In an exemplary embodiment, a method for an air filter for a HVAC system, comprises: fabricating a filter medium comprising one or more media layers for removing contaminants from an airstream; disposing the filter medium within a frame for supporting the filter medium within the HVAC system; configuring a differential temperature sensor for determining a pressure difference across the filter medium; and coupling the differential temperature sensor with the filter medium.

In another exemplary embodiment, coupling comprises incorporating the differential temperature sensor into the frame. In another exemplary embodiment, configuring the differential temperature sensor comprises: positioning an upstream temperature sensor on an atmospheric-pressure side of the filter medium; positioning a downstream temperature sensor on a low-pressure side of the filter medium; and configuring circuitry to receive signals from the upstream temperature sensor and the downstream temperature sensor.

In another exemplary embodiment, configuring the circuitry comprises disposing the circuitry in a remote location of the HVAC system and electrically coupling the circuitry with the differential temperature sensor. In another exemplary embodiment, configuring the differential temperature sensor includes configuring the upstream temperature sensor to measure a first temperature of the airstream upstream of the filter medium and configuring the downstream temperature sensor to measure a second temperature of the airstream downstream of the filter medium.

In another exemplary embodiment, configuring the circuitry includes configuring the circuitry to determine a temperature difference between the first temperature and the second temperature. In another exemplary embodiment, configuring the circuitry includes configuring the circuitry to use the temperature difference to determine a pressure difference between the low-pressure side and the atmospheric-pressure side of the filter medium. In another exemplary embodiment, configuring the circuitry includes configuring the circuitry to provide a signal to a practitioner that the air filter requires cleaning or replacement when the pressure difference reaches a predetermined threshold value. In another exemplary embodiment, configuring the circuitry includes configuring the circuitry to wirelessly communicate the with any one or more of a desktop, a tablet, a server, a mobile phone, a personal digital assistant, a personal communicator, a network router or hub, a wireless access point or repeater, a set-top box, or any combination thereof.

In another exemplary embodiment, configuring the differential temperature sensor comprises: coupling at least one temperature sensor coupled with the filter medium; and configuring circuitry to receive signals from the at least one at least one temperature sensor.

In another exemplary embodiment, coupling comprises coupling an upstream temperature sensor with the filter medium and coupling a downstream temperature sensor with the filter medium. In another exemplary embodiment, coupling comprises attaching the at least one temperature sensor to the filter medium on either an atmospheric-pressure side or a low-pressure side of the air filter. In another exemplary embodiment, coupling the at least one temperature sensor comprises providing an ultrathin thermistor having a thermally sensitive resistor and corresponding electrical connections that are housed within an epoxy-coated portion.

In another exemplary embodiment, coupling the at least one temperature sensor comprises configuring the at least one temperature sensor to measure a filter temperature of the filter medium. In another exemplary embodiment, configuring the circuitry includes configuring the circuitry to determine a temperature difference between the filter temperature and a temperature of the airstream upstream of the filter medium.

In another exemplary embodiment, configuring the circuitry includes configuring the circuitry to use the temperature difference to determine a pressure difference between a low-pressure side of the filter medium and an atmospheric-pressure side of the filter medium. In another exemplary embodiment, configuring the circuitry includes configuring the circuitry to provide a signal to a practitioner that the air filter requires cleaning or replacement when the pressure difference reaches a predetermined threshold value. In another exemplary embodiment, configuring the circuitry includes configuring the circuitry to wirelessly communicate the with any one or more of a desktop, a tablet, a server, a mobile phone, a personal digital assistant, a personal communicator, a network router or hub, a wireless access point or repeater, a set-top box, or any combination thereof.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary use environment wherein a HVAC system air filter is incorporated into a HVAC system of a building, according to the present disclosure;

FIG. 2 illustrates a schematic view of an exemplary embodiment of a HVAC system comprising a HVAC air filter in accordance with the present disclosure;

FIG. 3 illustrates an exemplary embodiment of an air filter having a differential temperature sensor coupled with a supportive frame of the air filter, according to the present disclosure;

FIG. 4 illustrates a cross-sectional view of an air filter coupled with an exemplary embodiment of a differential temperature sensor configured to detect a change in temperature of an airstream due to a buildup of contaminants in accordance with the present disclosure;

FIG. 5 illustrates a cross-sectional view of an air filter coupled with an exemplary embodiment of a differential temperature sensor configured to detect a change in temperature of a filter medium due to a buildup of contaminants in accordance with the present disclosure;

FIG. 6 illustrates an exemplary embodiment of a probe thermistor that may be incorporated into the differential temperature sensor shown in FIG. 4;

FIG. 7 illustrates an exemplary embodiment of an ultrathin thermistor that may be incorporated into the differential temperature sensor shown in FIG. 5;

FIG. 8 is a block diagram illustrating an exemplary embodiment of power circuit for supplying electrical power to a differential temperature detector, according to some embodiments; and

FIG. 9 provides an exemplary block illustration of a data processing system that may be used in conjunction with an air filter and differential temperature detector in accordance with various embodiments of the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the air filter system and methods disclosed herein may be practiced without these specific details. In other instances, specific numeric references such as “first media layer,” may be made. However, the specific numeric reference should not be interpreted as a literal sequential order but rather interpreted that the “first media layer” is different than a “second media layer.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, a HVAC system air filter comprises fibrous materials configured to remove solid particulates, such as dust, pollen, mold, and bacteria from an airstream passing through the HVAC system. Filters may be made from paper, foam, cotton, spun fiberglass, or other known filter materials. A drawback to conventional HVAC system air filters is that highly effective air filters capable of removing very small contaminants tend to restrict the airstream through the air filter, thereby making the HVAC system work harder and consume more energy. As such an air filter becomes increasingly clogged with contaminants, the pressure downstream of the filter drops while the atmospheric air pressure upstream of the filter remains the same. When the pressure differential becomes too great, due to clogging, the filter may tear or burst, allowing contaminants to be pulled beyond the air filter. Thus, the performance of a conventional HVAC system air filter (i.e., air flow through the filter and its ability to remove contaminants from the airstream) decreases over the course of the filter's service life.

Embodiments presented herein disclose a HVAC system air filter that can detect a temperature differential across the filter, due to contaminant buildup, and thus determine a corresponding pressure differential across the filter so as to provide insight as to when to periodically clean and reuse the filter to minimize obstructed air flow through the HVAC system.

Although embodiments presented herein may be described and illustrated in terms of a rectangular air filter, it should be understood that the air filter is not to be limited to the exact embodiments or shapes illustrated, but rather the air filter may include a wide variety of generally rectangular shapes, generally square, circular, oval, round, curved, conical, or other closed perimeter shape that will become apparent. Moreover, embodiments as described herein are not limited to use with an HVAC system and may find applicability in any of various other filtration systems configured to treat a large volume of air.

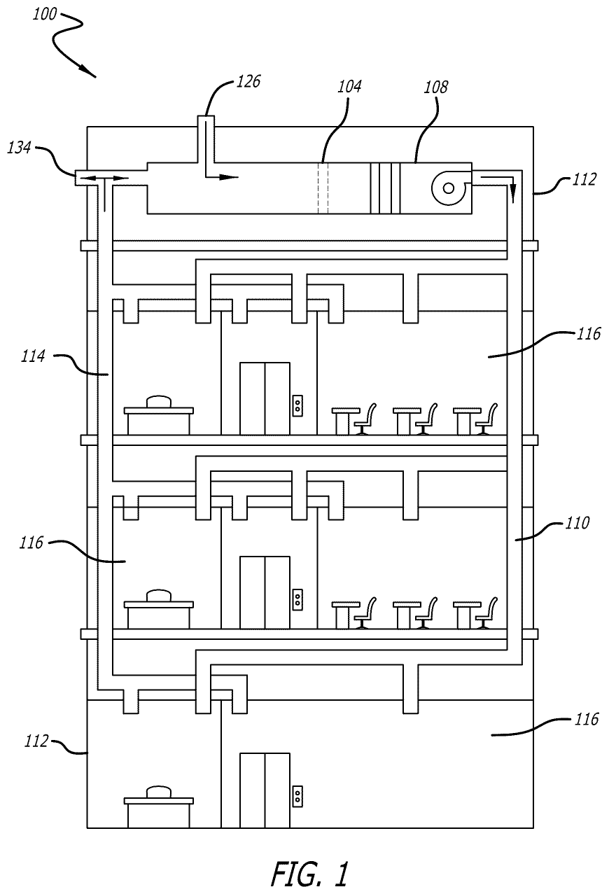

FIG. 1 illustrates an exemplary-use environment 100 wherein an air filter 104 is incorporated into a HVAC system 108 of a building 112 so as to clean an airstream drawn through the air filter 104. Although the building 112 illustrated in FIG. 1 comprises a multi-story office building, it should be understood that the building 112 may comprise any of various inhabitable structures, such as residential homes, apartments, condominiums, and the like. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which may include one or more building spaces 116, as illustrated in FIG. 1, or may comprise a single-story building, including but not limited to a detached residential home.

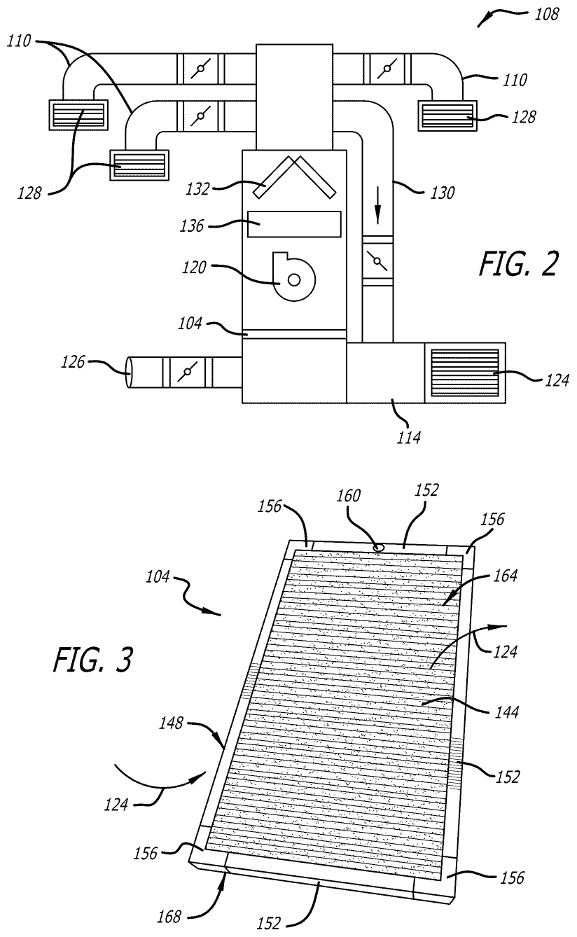

FIG. 2 illustrates a schematic view of an exemplary embodiment of a HVAC system 108 that may be used to clean air within building spaces 116. In some embodiments, however, the HVAC system 108 may be configured to clean air within interior spaces of any of a wide variety of buildings without limitation. The HVAC system 108 generally comprises a fan 120 configured to draw a return airstream 124 from the building spaces 116 through the air filter 104 whereby airborne molecular contaminants or other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 so as to maintain a desired barometric pressure within the HVAC system 108 and within the building spaces 116. In some embodiments, an exhaust airstream 134 may be further incorporated into the HVAC system 108 so as to maintain the desired barometric pressure and to allow entry of the outside airstream 126.

FIG. 3 illustrates an exemplary embodiment of an air filter 104 according to the present disclosure. The air filter 104 generally comprises a filter medium 144 within a supportive frame 148. The supportive frame 148 is configured to orient the air filter 104 within the HVAC system 108 such that the return air stream 124 is directed through the filter medium 144. As such, the supportive frame 148 comprises a shape and size suitable for supporting the air filter 104 within the HVAC system 108. It will be appreciated that the shape and size of the supportive frame 148 will vary depending upon a make and model of the HVAC system 108 for which the air filter 104 is intended to be used.

In some embodiments, the supportive frame 148 may comprise various fastening, or supportive, structures and materials suitably configured for securing the air filter 104 within a particular HVAC system 108. To this end, in the embodiment illustrated in FIG. 3, the supportive frame 148 comprises a plurality of elongate sections 152 and corner sections 156 disposed along the perimeter edges of the filter medium 144 and configured to support the filter medium 144 within the HVAC system 108. In other embodiments, however, the supportive frame 148 may comprise any of various rigid supports and recesses configured to orient the air filter 104 within various makes and models of HVAC system 108. As will be recognized, the supportive frame 148 may be configured with a variety of different shapes than the shape of the supportive frame illustrated in FIG. 3. It should be understood, therefore, that the various structures, shapes, and materials incorporated into the supportive frame 148, and thus the air filter 104 as a whole, may vary depending upon the particular HVAC system 108 for which the air filter 104 is intended to be used without detracting from the spirit and scope of the present disclosure.

It is contemplated that a practitioner may periodically clean the filter medium 144 rather than replacing the air filter 104, as is typically done with conventional air filter systems. It is envisioned that the air filter 104 may be removed from the HVAC system 108, any trapped debris may then be removed from the HVAC system 108. In some embodiments, the elongate sections 152 and the corner sections 156 may be disassembled to release the filter medium 144 from the supportive frame 148 and then a water hose may be used to flush contaminants from the filter medium 144, thereby leaving the filter clean and ready for reuse. In some embodiments, wherein the filter medium 144 comprises a filter oil composition, a solvent may be used to remove the filter oil from the filter medium 144. Once the filter medium 144 is sufficiently dry, a suitably formulated filter oil composition may be applied and allowed to wick into the filter medium 144. The elongate sections 152 and corner sections 156 may then be assembled onto the filter medium, as described above, and the air filter 104 may be reinstalled into the HVAC system 108. Various other cleaning methods will be apparent to those skilled in the art without deviating from the spirit and scope of the present disclosure.

As further illustrated in FIG. 3, an exemplary embodiment of a differential temperature sensor 160 is incorporated into the supportive frame 148. The differential temperature sensor 160 is configured to detect a change in temperature across the filter 104 due to contaminant buildup in the filter medium 144. It is contemplated that the change in temperature detected can be used to determine a corresponding pressure differential across the filter 104 and thus provide insight as to when to clean or replace the filter 104 to minimize obstructed air flow through the HVAC system.

It should be understood that as the air filter 104 removes particle contaminants from the airstream 124, the contaminants become entrapped in the filter medium 144. As the volume of contaminants grows, so does resistance to the airstream 124 flowing through the air filter 104. Consequently, the air pressure downstream of the air filter 104 decreases with respect to the atmospheric pressure upstream of the air filter 104, giving rise to a low-pressure side 164 of the air filter 104 and an atmospheric-pressure side 168 of the air filter 104, as shown in FIG. 3. The difference in pressure between the low-pressure side 164 and the atmospheric-pressure side 168 of the air filter 104 causes the airstream 124 to lose energy during crossing the resistive filter medium 144. In general, the energy loss leads to a drop in temperature of the airstream 124 across the filter medium and gives rise to an increase in temperature of the air filter 104. In some embodiments, the differential temperature sensor 160 may be configured to measure the drop in temperature across the air filter 104. The temperature difference can then be used to indicate when the pressure across the filter medium 144 reaches a predetermined threshold value, at which point the air filter 104 may be serviced or replaced to minimize the energy consumption of the HVAC system 108.

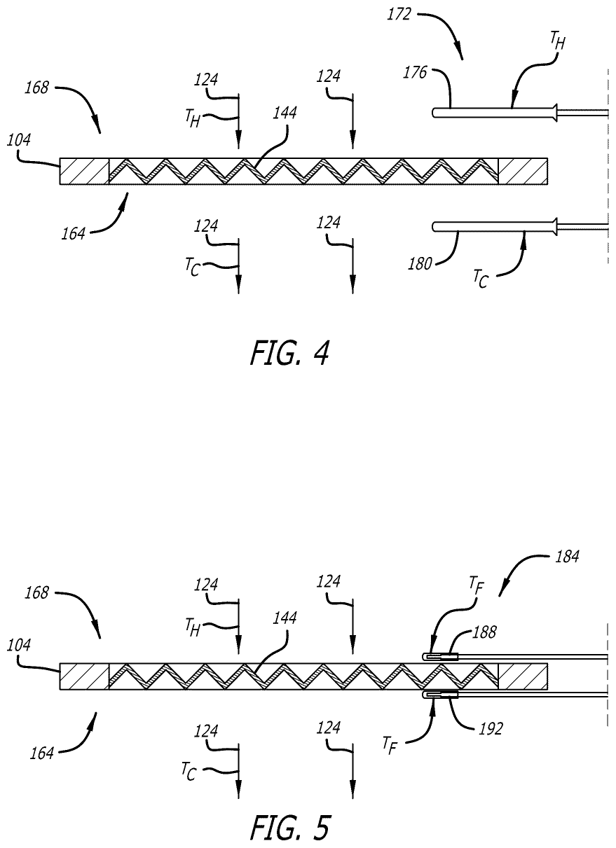

FIG. 4 illustrates a cross-sectional view of an air filter 104 coupled with an exemplary embodiment of a differential temperature sensor 172. The differential temperature sensor 172 is configured to detect a change in temperature of an airstream 124 due to a buildup of contaminants in a filter medium 144 of the air filter 104 in accordance with the present disclosure. The contaminants cause the airstream 124 to lose energy during crossing through the filter medium 144. As shown in FIG. 4, the airstream 124 upstream of the filter medium 144 has a temperature T_{H} while the airstream 124 downstream of the filter medium 144 has a temperature T_{C}, wherein T_{H} is greater than T_{C}. The differential temperature sensor 172 includes an upstream temperature sensor 176 and a downstream temperature sensor 180. As shown in FIG. 4, the temperature sensors 176, 180 are respectively positioned within the airstream 124 upstream and downstream of the filter medium 144. Further, although the temperature sensors 176, 180 are shown just above and below the air filter 104, it should be borne in mind that the temperature sensors 176, 180 may be disposed in any of various suitable locations with the HVAC system 108, without limitation.

With continuing reference to FIG. 4, the upstream temperature sensor 176 is configured to measure the temperature T_{H} of the airstream 124 upstream of the filter medium 144 while the downstream temperature sensor 180 is configured to measure the temperature T_{C} of the airstream 124 downstream of the filter medium 144. As described above, the difference in temperature (e.g., T_{H}−T_{C}) can be used to determine a difference in pressure between a low-pressure side 164 and an atmospheric-pressure side 168 of the air filter 104. The temperature difference can then be used to indicate when the pressure across the filter medium 144 reaches a predetermined threshold value, at which point the air filter 104 may be serviced or replaced to minimize the energy consumption of the HVAC system 108.

In some embodiments, the differential temperature sensor 172 includes suitable circuitry (not shown), such as one or more microcontrollers, that is capable of receiving signals from the temperature sensors 176, 180 and communicating a corresponding difference in air pressure on opposite sides of the air filter 104. In some embodiments, the circuitry is disposed in a remote location of the HVAC system 108 and is electrically coupled with the differential temperature sensor 172, such as by way of wires. When the pressure difference reaches a predetermined threshold value, the circuitry comprising the differential temperature sensor 172 indicates or provides a signal to a practitioner that the air filter 104 requires cleaning or replacement. It is contemplated that the circuitry comprising the differential temperature sensor 172 is configured to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof, as described herein.

FIG. 5 illustrates a cross-sectional view of an air filter 104 coupled with an exemplary embodiment of a differential temperature sensor 184 configured to detect a change in temperature of a filter medium 144 due to a buildup of contaminants in accordance with the present disclosure. As described hereinabove, the contaminants cause the airstream 124 to lose energy during crossing through the filter medium 144. Consequently, the filter medium 144 has a temperature T_{F} that increases as heat transfers from the airstream 124 to the filter medium 144. As shown in FIG. 5, the airstream 124 upstream of the filter medium 144 has a temperature T_{H} while the airstream 124 downstream of the filter medium 144 has a temperature T_{C}, wherein T_{H} is greater than T_{C}. In the illustrated embodiment, the differential temperature sensor 184 includes an upstream temperature sensor 188 and a downstream temperature sensor 192. The upstream temperature sensor 188 is attached to the filter medium 144 on an atmospheric-pressure side 168 of the air filter 104. The downstream temperature sensor 192 is attached to the filter medium 144 on a low-pressure side 164 of the air filter 104. It is contemplated, however, that in some embodiments, only one of the temperature sensors 188, 192 may be coupled with the filter medium 144, as desired.

With continuing reference to FIG. 5, either or both of the temperature sensors 188, 192 are configured to measure the temperature T_{F} of the filter medium 144. The increase in temperature of the filter medium 144 can be determined by computing the difference in temperature between the measured temperature of the filter medium T_{F} and the temperature T_{H} of the airstream 124 upstream of the filter medium 144 (e.g., T_{F}−T_{H}). The temperature increase of the filter medium 144 can then be used to determine a corresponding difference in air pressure across the filter medium 144. When the determined pressure difference is found to have reached a predetermined threshold value, a practitioner may be alerted that the air filter 104 must be serviced or replaced to minimize the energy consumption of the HVAC system 108.

As described with respect to FIG. 4, the differential temperature sensor 184 may, in some embodiments, include suitable circuitry (not shown), such as one or more microcontrollers, that is capable of receiving signals from the temperature sensors 188, 192 and communicating a corresponding difference in air pressure on opposite sides of the air filter 104. In some embodiments, the circuitry is disposed in a remote location of the HVAC system 108 and is electrically coupled with the differential temperature sensor 184, such as by way of wires. When the pressure difference reaches a predetermined threshold value, the circuitry comprising the differential temperature sensor 184 indicates or provides a signal to a practitioner that the air filter 104 must be cleaned or replaced. It is contemplated that the circuitry comprising the differential temperature sensor 184 is configured to wirelessly communicate the air pressure difference to any one or more of a desktop, a tablet, a server, a mobile phone, a personal digital assistant (PDA), a personal communicator, a network router or hub, a wireless access point (AP) or repeater, a set-top box, or any combination thereof, as described herein.

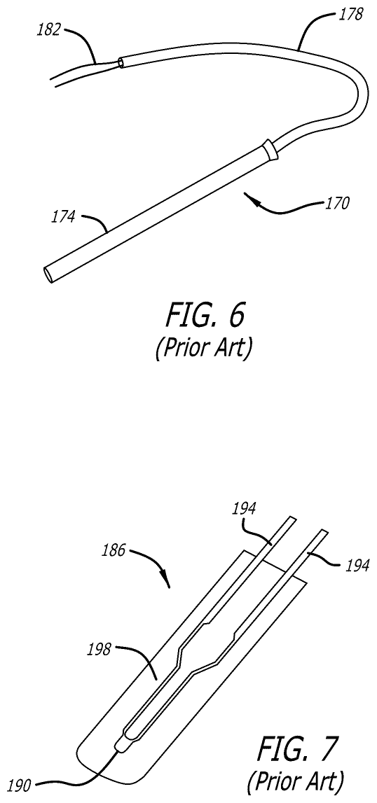

It is contemplated that a wide variety of thermistors may be incorporated into the differential temperature sensors 172, 184 disclosed herein, without limitation. For example, FIG. 6 illustrates an exemplary probe thermistor 170 that may be incorporated into the differential temperature sensor 172 shown in FIG. 4. The probe thermistor 170 is a typical resistance thermometer comprising metallic oxides or ceramics disposed within a cylindrical cartridge 174. Wires 178 couple the resistance thermometer with an electrical connector 182. Thus, the cartridge 174 can be used to measure temperatures, while the wires 178 and the connector 182 can be used to convey changing resistance values to circuitry that can interpret the changing resistance values as corresponding temperatures. The probe thermistor 170 may comprise either a negative temperature coefficient (NTC) thermistor or a positive temperature coefficient (PTC) thermistor. As will be appreciated, therefore, the probe thermistor 170 may comprise either or both of the temperature sensors 176, 180, as desired.

FIG. 7 illustrates an exemplary ultrathin thermistor 186 that may be incorporated into the differential temperature sensor 184 shown in FIG. 5. The ultrathin thermistor 186 comprises a thermally sensitive resistor 190 and corresponding electrical connections 194 that are housed within an epoxy-coated portion 198. The thermally sensitive resistor 190 can be used to measure temperatures, while the electrical connections 194 can be used to convey changing resistance values to circuitry that can interpret the changing resistance values as corresponding temperatures. The ultrathin thermistor 186 may comprise either a negative temperature coefficient (NTC) thermistor or a positive temperature coefficient (PTC) thermistor. The ultrathin thermistor 186 is extremely small. In one embodiment, the ultrathin thermistor 186 has a length of about 20 mm, a width of about 4.5 mm, and a thickness of about 0.5 mm. As such, the ultrathin thermistor 190 is very well-suited for being attached directly to the filter medium 144, as indicated in FIG. 5.

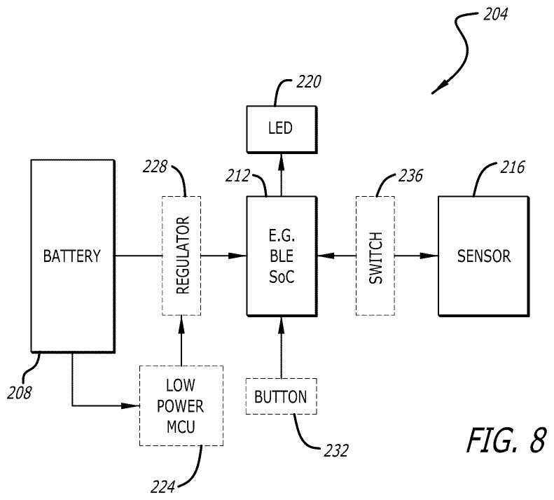

FIG. 8 is a block diagram illustrating an exemplary embodiment of power circuit 204 for supplying electrical power to a differential temperature sensor, such as the differential pressure sensors 172, 184 respectively of FIGS. 4, 5. The power circuit 204 may, in some embodiments, be incorporated into a HVAC system 108 that is configured to operate with air filters that include pressure differential sensors, such as the sensors 172, 184. In some embodiments, however, the power circuit 204 may be incorporated into a portion of the air filter 104, such as the supportive frame 148 (see FIG. 3), without limitation.

In the illustrated embodiment of FIG. 8, the power circuit 204 includes a removable battery 208, an integrated circuit 212, a sensor 216, and a light emitting diode (LED) 220. The removable battery 208 may comprise including any suitable battery chemistry, such as, by way of example, Li-ion, Lipo, NiMH, Lithium-thionyl chloride (Li-SOCl2), Alkaline cells, coin cells (CR2032), and the like, without limitation. The sensor 216 may comprise any sensor capable of detecting a difference in pressure on opposite sides of an air filter 104, as described herein. The integrated circuit 212 may be configured to receive and process signals received from the sensor 216. The integrated circuit 212 may be configured to signal when the difference in pressure reaches a threshold value that indicates the air filter 104 needs to be cleaned or replaced.

In some embodiments, the integrated circuit 212 comprises any of a Bluetooth Low Energy System on a Chip (BLE SoC), a WiFi Module, a Bluetooth Module, and the like, without limitation. For example, in some embodiments, wherein the integrated circuit 212 is configured to communicate wirelessly by way of WiFi or Bluetooth, the integrated circuit 212 may signal an application stored on a user's mobile device to display a notification to the user when the air filter 104 needs to be cleaned or replaced. In some embodiments, the integrated circuit 212 may be configured to signal a Home Automation Gateway to send notifications to the user. Various other communication techniques will be apparent to those skilled in the art without deviating from the spirit and scope of the present disclosure.

The LED 220 may be configured to provide visual signals to a practitioner. For example, the LED 220 may illuminate to indicate when the power circuit 204 is operating. In some embodiments, however, the LED 220 may illuminate only when the air filter 104 needs to be cleaned or replaced. Further, in some embodiments, the LED 220 may illuminate with a first color when the power circuit 204 is operating normally and then change to a second color when the pressure across the air filter 104 has reached a threshold value. In some embodiments, the LED 220 may be configured to flash when the pressure has reached the threshold valve. Further, in some embodiments, the LED 220 may be coupled with a speaker or a piezoelectric device capable of issuing an audible signal. It is contemplated that in such an embodiment, the audible signals may comprise a beeping sound that accompanies the flashing of the LED 220 when the air filter 104 needs to be cleaned or replaced.

With continuing reference to FIG. 8, in some embodiments the power circuit 204 may include a low power microcontroller (MCU) 224 and/or a regulator 228, a button 232, and/or a switch 236. In some embodiments, the regulator 228 may be a linear low-quiescent-current regulator. In some embodiments, the power circuit 204 may be configured to operate at lower voltages to reduce quiescent currents, thereby obviating a need for the regulator 228. In some embodiments, however, the low power MCU 224 may be configured to operate in conjunction with the regulator 228 to regulate quiescent currents. Further, the switch 236 may comprise a MOSFET adapted to turn off unused circuitry when the integrated circuit 212 is in a quiescent state. Further, when the difference in air pressure across the air filter 104 comprises a relatively small value, the switch 236 may turn off the sensor 216 to reduce the processing load on the integrated circuit 212.

The button 232 may be configured to provide a manual interface between the power circuit 204 and a practitioner. For example, the button 232 may enable the practitioner to turn the power circuit 204 on and off, as desired. In some embodiments, the button 232 may be configured to enable the practitioner to affect the operation of the integrated circuit 212. In some embodiments, for example, the button 232 may be configured to turn off the LED 220 after the air filter 104 has been cleaned. Further, in some embodiments, the button 232 may be configured to enable the practitioner to select from among various operational modes of the power circuit 204.

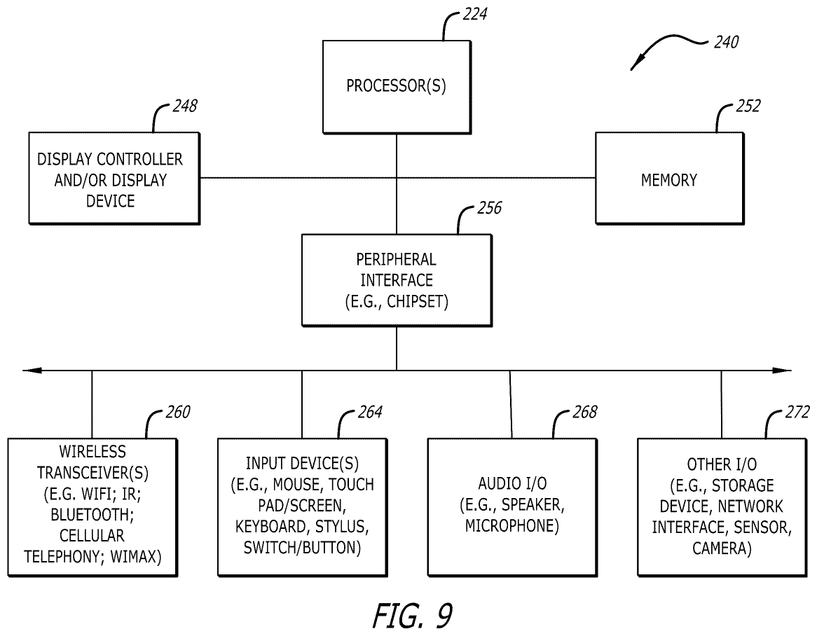

Turning, now, to FIG. 9, a block diagram illustrates an exemplary data processing system 240 that may be used in conjunction with the air filter 104 and the differential temperature sensors 172, 184 to perform any of the processes or methods described herein. System 240 may represent circuitry within a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 9, system 240 includes a processor 244 and a peripheral interface 256, also referred to herein as a chipset, to couple various components to the processor 244, including a memory 252 and devices 260-272 via a bus or an interconnect. Processor 244 may represent a single processor or multiple processors with a single processor core or multiple processor cores included therein. Processor 244 may represent one or more general-purpose processors such as a microprocessor, a central processing unit (CPU), or the like. More particularly, processor 244 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 244 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 244 is configured to execute instructions for performing the operations and steps discussed herein.

Peripheral interface 256 may include a memory control hub (MCH) and an input output control hub (ICH). Peripheral interface 256 may include a memory controller (not shown) that communicates with a memory 252. The peripheral interface 256 may also include a graphics interface that communicates with graphics subsystem 248, which may include a display controller and/or a display device. The peripheral interface 256 may communicate with the graphics device 248 by way of an accelerated graphics port (AGP), a peripheral component interconnect (PCI) express bus, or any other type of interconnect.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 244. In such a configuration, the peripheral interface 256 operates as an interface chip performing some functions of the MCH and ICH. Furthermore, a graphics accelerator may be integrated within the MCH or the processor 244.

Memory 252 may include one or more volatile storage (or memory) devices, such as random access memory (RAM), dynamic RAM (DRAM), synchronous DRAM (SDRAM), static RAM (SRAM), or other types of storage devices. Memory 252 may store information including sequences of instructions that are executed by the processor 244, or any other device. For example, executable code and/or data of a variety of operating systems, device drivers, firmware (e.g., input output basic system or BIOS), and/or applications can be loaded in memory 252 and executed by the processor 244. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 256 may provide an interface to IO devices, such as the devices 260-272, including wireless transceiver(s) 260, input device(s) 264, audio IO device(s) 268, and other IO devices 272. Wireless transceiver 260 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 264 may include a mouse, a touch pad, a touch sensitive screen (which may be integrated with display device 248), a pointer device such as a stylus, and/or a keyboard (e.g., physical keyboard or a virtual keyboard displayed as part of a touch sensitive screen). For example, the input device 264 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 268 may include a speaker and/or a microphone to facilitate voice-enabled functions, such as voice recognition, voice replication, digital recording, and/or telephony functions. Other optional devices 272 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 272 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 9 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Methods for an air filter 104 for a HVAC system 108 may, in some embodiments, comprise fabricating a filter medium 144 comprising one or more media layers for removing contaminants from an airstream; disposing the filter medium 144 within a frame 148 for supporting the filter medium 144 within the HVAC system 108; configuring a differential temperature sensor for determining a pressure difference across the filter medium 144; and coupling the differential temperature sensor with the filter medium. In some embodiments, coupling the differential temperature sensor with the filter medium may comprise incorporating the differential temperature sensor 160 into the frame 148. Further, configuring the circuitry 204 may, in some embodiment, comprise disposing the circuitry 204 in a remote location of the HVAC system 108 and electrically coupling the circuitry 204 with the differential temperature sensor 172.

In some embodiments, configuring the differential temperature sensor 172 may comprise: positioning an upstream temperature sensor 176 on an atmospheric-pressure side 168 of the filter medium 144; positioning a downstream temperature sensor 180 on a low-pressure side 164 of the filter medium 144; and configuring circuitry 204 to receive signals from the upstream temperature sensor 176 and the downstream temperature sensor 180. In some embodiments, however, configuring the differential temperature sensor may include configuring the upstream temperature sensor 176 to measure a first temperature of the airstream 124 upstream of the filter medium 144 and configuring the downstream temperature sensor 180 to measure a second temperature of the airstream 124 downstream of the filter medium 144. Further, in some embodiments, configuring the circuitry 204 may include configuring the circuitry 204 to determine a temperature difference between the first temperature and the second temperature. Configuring the circuitry 204 may, in some embodiments, include configuring the circuitry 204 to use the temperature difference to determine a pressure difference between the low-pressure side 164 and the atmospheric-pressure side 168 of the filter medium 144. In some embodiments, configuring the circuitry 204 may further include configuring the circuitry 204 to provide a signal to a practitioner that the air filter 104 requires cleaning or replacement when the pressure difference reaches a predetermined threshold value. In some embodiments, configuring the circuitry 204 may further include configuring the circuitry 204 to wirelessly communicate the with any one or more of a desktop, a tablet, a server, a mobile phone, a personal digital assistant, a personal communicator, a network router or hub, a wireless access point or repeater, a set-top box, or any combination thereof.

In some embodiments, configuring the differential temperature sensor 184 may comprise: coupling at least one temperature sensor coupled with the filter medium; and configuring circuitry 204 to receive signals from the at least one at least one temperature sensor. In some embodiments, coupling the at least one temperature sensor comprises coupling an upstream temperature sensor 188 with the filter medium and coupling a downstream temperature sensor 192 with the filter medium. Further, in some embodiments, coupling the at least one temperature sensor comprises attaching the at least one temperature sensor to the filter medium 144 on either an atmospheric-pressure side 168 or a low-pressure side 164 of the air filter 104. Further, in some embodiments, coupling the at least one temperature sensor comprises providing an ultrathin thermistor 186 having a thermally sensitive resistor 190 and corresponding electrical connections 194 that are housed within an epoxy-coated portion 198.

Moreover, in some embodiments, coupling the at least one temperature sensor may comprise configuring the at least one temperature sensor to measure a filter temperature of the filter medium 144. The circuitry 204 may, in some embodiments, be configured to determine a temperature difference between the filter temperature and a temperature of the airstream 124 upstream of the filter medium 144. Further, in some embodiments, the circuitry 204 may be configured to use the temperature difference to determine a pressure difference between a low-pressure side 164 of the filter medium 144 and an atmospheric-pressure side 168 of the filter medium 144. In some embodiments, configuring the circuitry 204 may include configuring the circuitry 204 to provide a signal to a practitioner that the air filter 104 requires cleaning or replacement when the pressure difference reaches a predetermined threshold value. Further, in some embodiments, configuring the circuitry 204 may include configuring the circuitry 204 to wirelessly communicate the with any one or more of a desktop, a tablet, a server, a mobile phone, a personal digital assistant, a personal communicator, a network router or hub, a wireless access point or repeater, a set-top box, or any combination thereof.

While the air filter system and methods have been described in terms of particular variations and illustrative figures, those of ordinary skill in the art will recognize that the air filter is not limited to the variations or figures described. In addition, where methods and steps described above indicate certain events occurring in certain order, those of ordinary skill in the art will recognize that the ordering of certain steps may be modified and that such modifications are in accordance with the variations of the air filter system. Additionally, certain of the steps may be performed concurrently in a parallel process, when possible, as well as performed sequentially as described above. To the extent there are variations of the air filter system, which are within the spirit of the disclosure or equivalent to the air filter system found in the claims, it is the intent that this patent will cover those variations as well. Therefore, the present disclosure is to be understood as not limited by the specific embodiments described herein, but only by scope of the appended claims.

What is claimed is:

1. An air filter for a HVAC system, comprising:
a filter medium comprising one or more media layers for removing contaminants from an airstream;
a frame for supporting the filter medium within the HVAC system; and
a differential temperature sensor for determining a pressure difference across the filter medium.

2. The air filter of claim 1, wherein the differential temperature sensor is incorporated into the frame.

3. The air filter of claim 1, wherein the differential temperature sensor comprises: an upstream temperature sensor; a downstream temperature sensor; and circuitry configured to receive signals from the upstream temperature sensor and the downstream temperature sensor.

4. The air filter of claim 3, wherein one or both of the upstream temperature sensor and the downstream temperature sensor comprise probe thermistors configured to be disposed in the airstream.

5. The air filter of claim 3, wherein the circuitry is disposed in a remote location of the HVAC system and is electrically coupled with the differential temperature sensor.

6. The air filter of claim 3, wherein the upstream temperature sensor and the downstream temperature sensor are positioned within the airstream respectively upstream and downstream of the filter medium.

7. The air filter of claim 6, wherein the upstream temperature sensor is configured to measure a first temperature of the airstream upstream of the filter medium while the downstream temperature sensor is configured to measure a second temperature of the airstream downstream of the filter medium.

8. The air filter of claim 7, wherein the circuitry is configured to determine a temperature difference between the first temperature and the second temperature.

9. The air filter of claim 8, wherein the circuitry is configured to use the temperature difference to determine a pressure difference between a low-pressure side of the filter medium and an atmospheric-pressure side of the filter medium.

10. The air filter of claim 9, wherein the circuitry is configured to provide a signal to a practitioner that the air filter requires cleaning or replacement when the pressure difference reaches a predetermined threshold value.

11. The air filter of claim 10, wherein the circuitry is configured to wirelessly communicate the with any one or more of a desktop, a tablet, a server, a mobile phone, a personal digital assistant, a personal communicator, a network router or hub, a wireless access point or repeater, a set-top box, or any combination thereof.

12. The air filter of claim 1, wherein the differential temperature sensor comprises: at least one temperature sensor coupled with the filter medium; and circuitry configured to receive signals from the at least one at least one temperature sensor.

13. The air filter of claim 12, wherein the at least one temperature sensor comprises an upstream temperature sensor and a downstream temperature sensor.

14. The air filter of claim 12, wherein the at least one temperature sensor is attached to the filter medium on either an atmospheric-pressure side or a low-pressure side of the air filter.

15. The air filter of claim 12, wherein the at least one temperature sensor comprises an ultrathin thermistor having a thermally sensitive resistor and corresponding electrical connections that are housed within an epoxy-coated portion.

16. The air filter of claim 12, wherein the at least one temperature sensor is configured to measure a filter temperature of the filter medium.

17. The air filter of claim 16, wherein the circuitry is configured to determine a temperature difference between the filter temperature and a temperature of the airstream upstream of the filter medium.

18. The air filter of claim 17, wherein the circuitry is configured to use the temperature difference to determine a pressure difference between a low-pressure side of the filter medium and an atmospheric-pressure side of the filter medium.

19. The air filter of claim 18, wherein the circuitry is configured to provide a signal to a practitioner that the air filter requires cleaning or replacement when the pressure difference reaches a predetermined threshold value.

20. The air filter of claim 19, wherein the circuitry is configured to wirelessly communicate the with any one or more of a desktop, a tablet, a server, a mobile phone, a personal digital assistant, a personal communicator, a network router or hub, a wireless access point or repeater, a set-top box, or any combination thereof.
